(19) United States
(12) Patent Application Publication
(10) Pub. No.: US 2005/0188300 A1
(43) Pub. Date: Aug. 25, 2005

(54) Determination of member pages for a hyperlinked document with link and document analysis

(75) Inventors: James M. Sweet, Rochester, NY (US); Steven J. Harrington, Webster, NY (US); Rhys Price Jones, Rochester, NY (US); Andreas Savakis, Rochester, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 10/608,590

(22) Filed: Jun. 27, 2003

Related U.S. Application Data
(60) Provisional application No. 60/456,988, filed on Mar. 21, 2003.

(51) Int. Cl. G06F 15/00; G06F 17/24; G06F 17/21

(52) U.S. Cl. 715/514

(57) ABSTRACT

The present invention relates to a methodology for assembling a document from content spanning multiple web-pages employing two cooperative processes. Given a starting location, one process analyzes a single page at a time to find candidate links. The links are recursively followed and those pages are analyzed. A detailed set of heuristics is used to determine what is or is not a candidate link. The candidate pages are then fed to a document-level analyzer. This process compares the attributes of one page against the others and looks for a document-like structure. Using another detailed set of heuristics, the document-level analyzer determines if the page should be included in the document.

This application is based on a Provisional Patent Application No. 60/456,988, filed Mar. 3, 2003.

### RELATED CASES

Cross reference is made to the following related applications incorporated by reference herein and filed concurrently herewith: Attorney Docket Number D/A25555 entitled “DETERMINATION OF MEMBER PAGES FOR A HYPERLINKED DOCUMENT WITH RECURSIVE PAGE-LEVEL LINK ANALYSIS” and Attorney Docket Number D/A2555Q1 entitled “DETERMINATION OF TABLE OF CONTENT LINKS FOR A HYPERLINKED DOCUMENT” both of which are to inventors James M. Sweet, Steven J. Harrington, Rhys Price Jones, and Andreas Savakis.

### BACKGROUND

The present invention relates generally to the generation of a document for subsequent viewing or printing. The present invention also relates generally to hyperdocument or hypertext documents. More particularly, this invention relates to hyperlinked or hypertext documents and the generation of document representations thereof suitable for subsequent viewing or printing.

The most commonly experienced example of a hyperlinked document is a document on the World Wide Web. Such a hyperlinked document, may reside solely on a single display page (for example a single web page), or it may span multiple display pages, each such display page containing a section or chapter of the entire document. There are many reasons why a web author may wish to separate a document into multiple display pages (e.g. to breakdown content into more understandable segments, or simply to squeeze in more advertisements). However, such a decomposition poses a significant inconvenience for a user wishing to download or print the document for later viewing. Typically, the user must visit each page independently and perform the desired operation once for each page. Currently, the only alternatives to this manual approach are to download an entire directory, or to download the entire web site using a web archiving utility. The former is of some use but may not always retrieve all necessary display pages; the latter is an unacceptable solution given the bandwidth available to most users.

The following are articles which acknowledge the problems noted above:

Gibson, David and Kleinberg, Jon and Raghavan, Prabhakar, “Inferring Web Communities from Link Topology”, in Hypertext '98, pp. 225-234, ACM Publishing, 1998:

http://www.cs.cornell.edu/home/kleinber/ht98.ps

This reference suggests a method of grouping web pages, but on a macroscopic level that is unrelated to reconstruction of an individual document.

Yang, Jian and Ma, Wanli and Brent, Richard P., “From Hypertext to Flat Text: A Tool for Document Construction”, in Second Australian World Wide Web Conference, 1996:

http://ausweb.scu.edu.au/aw96/tech/wanli/

This reference shows a method of building a document out of hyperlinked pages which performs a primitive link analysis, but the criteria for including another link are limited and do not screen out extraneous pages.

Dobson, Simon and Burrill, Victoria, “Printing Hyperdocuments”, in ERCIM News (Online Edition), Vol. 20, January 1995:

http://www.ercim.org/publication/Ercim_News/enw20/hyperdoc.html

This reference suggests the inclusion of meta-information to indicate document structure among hyperlinked pages. This requires cooperation from the creator of the document and does not entail an automated approach.

All of the above are herein incorporated by reference in their entirety for their teaching.

Therefore, as discussed above, there exists a need for a simple to use method to assemble a document representation for the subsequent viewing or printing of a given hyperdocument, which nevertheless is robust in its ability to discern and gather all appropriate hyperlink components.

The present invention relates to an automated identification methodology for assembling document related hyperlinked pages. This methodology comprises performing a page-level link analysis that identifies those hyperlinks on a page linking to a candidate document page potentially part of the document. This is followed by performing recursive application of the page-level link analysis to the linked candidate document page and any further nested candidate document pages thereby identified, until a collective set of identified candidate document pages is assembled. There is then performed a document-level analysis that examines the collective set of identified candidate document pages for grouping into one or more documents.

The present invention also relates to a system identification methodology for assembling a hyperlinked document. This methodology comprises performing a page-level link analysis that identifies those hyperlinks on a page linking to a candidate document page utilizing a methodology further comprising identifying possible progression links, and identifying possible table of content links. This page-level link analysis is recursively applied to the linked candidate document page and any further nested candidate document pages thereby identified, until a collective set of identified candidate document pages is assembled. There is then performed a document-level analysis that examines the collective set of identified candidate document pages for grouping into one or more documents.

Further, the present invention relates to a system identification methodology for assembling a hyperlinked document. This methodology comprises performing a page-level link analysis that identifies those hyperlinks on a page linking to a candidate document page utilizing a methodology further comprising identifying possible progression links, identifying possible table of content links and then examining the possible progression links and the possible table of content links for common characteristics. This page-level link analysis is recursively applied to the linked candidate document page and any further nested candidate document pages thereby identified, until a collective set of identified candidate document pages is assembled. There is then performed a document-level analysis that examines the collective set of identified candidate document pages for grouping into one or more documents.

### BRIEF DESCRIPTION OF THE DRAWINGS

FIG. 1 provides a flow diagram that depicts the overall page membership system.

FIG. 2 shows a flow diagram of the page-level link analysis module.

FIG. 3 shows a flow diagram for the identification of progression indicators.

FIG. 4 provides a flow chart depicting the process of matching progression indicators with links.

FIG. 5 provides a flow diagram depicting a document-level analysis.

FIG. 6 illustrates four simple topological structures that typically occur in documents.

### DESCRIPTION

The invention described herein is a method to identify the hyperlinked components of a hypertext document. It is an identification methodology which recognizes that a single coherent document is often split across two or more distinct hypertext pages. It is of course assumed that the citation graph of all pages within the same document forms a single non-disjoint graph; in other words, one can traverse the entire document by following a trail of hypertext links that strictly resides inside the document boundary. The method herein comprises an approach whereby in one phase, a link analysis is applied iteratively to develop a group of candidate pages, and optionally in another phase, document analysis is used to group these candidate pages into one or more coherent documents.

One phase, a link analysis phase, consists of the identification for a given hypertext page of the most likely desirable intra-document links. Those intra-document links fall into two categories: progression links, which are indicated by a word, phrase, or graphic suggesting a directional movement through the document; and table of contents links, which are indicated by a logical grouping of links allowing access to all pages of the document.

The iterative application of the link analysis phase is embodied by a feedback loop through which the pages pointed to by likely intra-document links are then themselves examined for intra-document links, and so on, until all pages indicated by intra-document links are exhausted, or until some arbitrary stopping point has been reached.

The optional second phase, or document analysis phase, is the examination of groups of candidate pages identified by iterative application of the link analysis phase for two factors: page similarity, and document structure. The page similarity aspect is embodied by the correlation of content and/or meta-data between candidate pages. The document structure aspect is embodied by identification of known document structures using a vocabulary of commonly used simple document structural building blocks that are combined in either a compound, or a hierarchical manner.

The output of this second phase is a score based on both of the above factors indicating the degree to which one or more groups of candidate pages display document-like structures. If the invention is being employed in a context where it must be fully automated, the group of candidate pages with the highest score is chosen to represent the hypertext document.

When creating an effective hyperlinked, multi-page document, the authors need to provide the reader with clues that indicate the existence of other pages within the same document (for example, a link entitled “Next Page”). These are markers for the trail of associated hyperlinks. In the description which follows an automated document boundary detection system is described, that can seek out and identify characteristics of web pages and groups of web pages that may signal the existence of a multi-page web document. Using these clues, the system would then make a decision as to which web pages should be grouped together as part of the same document. Such a system can then be used to automate the process of printing or downloading a multi-page web document.

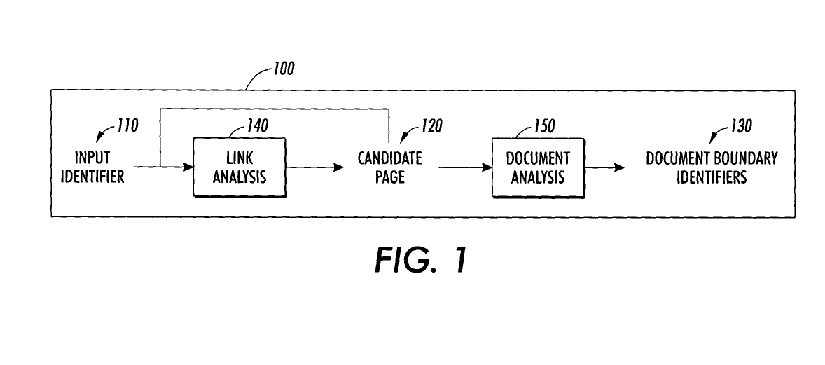

FIG. 1 shows the primary processes of a document boundary determining system 100. The document boundary detection system 100 would accept some starting document specification 110 such as a Uniform Resource Locator (URL). This can be any arbitrary page of the document, provided that it has the mechanisms that would allow a user to locate the remaining pages. The starting specification 110 is typically received from the user and indicates one of the pages of the document the user wishes to print or download. The document boundary detection system 100 would then output a list of page identifiers 130 such as URLs representing all pages which are included in that document. The boundary detection in one embodiment is carried out as a two-stage process. The first step for an automated system for the identification of multi-page documents is to identify links within a given web page that may link to other pages within the same document. Such links are referred to as intra-document links. This is done by a recursive, page-level, link analysis stage 140 that gathers a list of candidate pages 120. This is a recursive process whereby any discovered candidate pages are fed back into link analysis stage 140 for examination to locate further candidate pages 120. Thus if the original page 110 has a link to the next page of the document, then that next page is examined for a link to the third page, the third page would be examined in turn and so on until no new pages are found (or a limit on the allowed number of pages is reached.) In the optional document analysis stage 150, the system looks for commonalities and strong document structure among the candidate pages. This stage reduces the set of candidate pages to only the pages that co-reside within the same document.

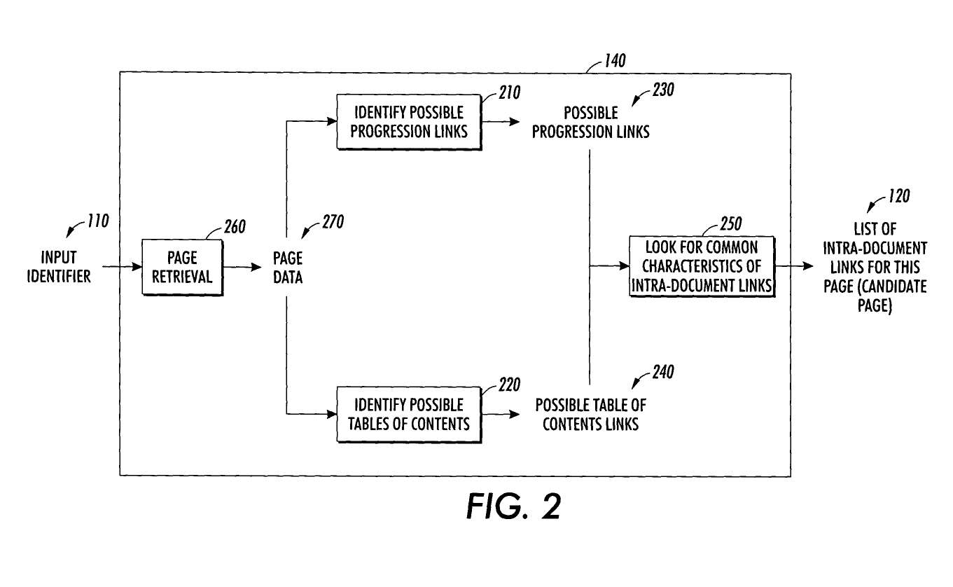

The page-level link analysis 140 is described in greater detail in FIG. 2. During page-level link analysis 140, the document detection system attempts to identify links that may potentially lead to other pages within the same document. It is assumed that a well-authored multi-page document will always include progression links (links that provide some well-defined progression through the document, often indicated by the presence of some well-known contextual clue, such as a graphic or text “next” or “previous” indicator) and/or table of contents links (clusters of links providing a path to every page or some logical subset of pages in the document) that indicate the structure of the document. These are the two categories of intra-document links that the link analysis process 140 seeks to identify.

The link analysis process begins with the retrieval of the actual page 270 for analysis from the page identifier 110. This is done as will be well understood by those skilled in the art, by the page retrieval process 260. The retrieved page 270 is then used as input to both the progression-link identification module 210 and the link-cluster identification module 220. In the progression-link identification module 210, possible progression links 230 are identified primarily by means of a progression indicator, which is a textual or graphical clue that suggests the nature of the progression link. Link-cluster identification module 220 examines the page data 270 to identify link clusters and thereby possible table of content type links 240. The possible progression links 230 and possible table of content links 240 are passed to module 250 for a final examination to weed out links which have properties that are not characteristic of typical intra-document links, e.g. they point to a different web server. The final result is then a list of intra-document links 120 for the candidate page 270.

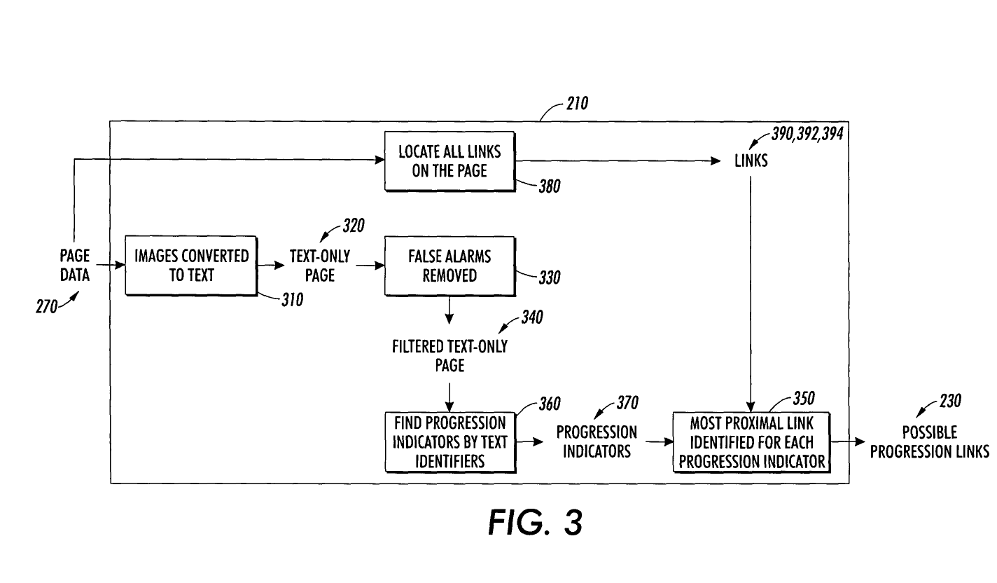

Details of the progression link identification module 210 are shown in FIG. 3. There are two concurrent internal paths in operation here. In one path, as indicated by block 380, a listing of all links appearing within the page is compiled which may include for example sample links 390, 392 and 394. Link 390 is a first possible link, link 392 being a second possible link, on through to link “n” 394 representing a possible total of “n” links.

As is depicted in FIG. 3, an additional path is provided for identifying graphical progression links. As shown here, the possible progression links 230 are identified primarily by means of a progression indicator, which is a contextual clue. A contextual clue is a content item intended to convey to the viewer the purpose of the link. For a link used to traverse the document, the contextual clue is typically manifest as a textual or graphical indicator that suggests the nature of the progression link. An example of a textual progression indicator would be the appearance of the text “Next Page” within or immediately adjacent to a link leading to the subsequent page of the document. In this case the text “Next Page” would be the contextual clue. In some cases the contextual clue takes the form of an image such as a right-pointing arrow. However, often in these cases, the filename associated with the image (such as the name “arrow.gif”) can yield some sort of alternate contextual clue. In anticipation of that the page data 270 is passed through image conversion module 310 that replaces the image graphic with text data. This results in a text-only page 320 that is fed to the filtering module 330 to screen out text elements that seem to match a set of likely progression words or phrases, but that convey a different meaning based on context. Module 330 is employed to avoid progression indicator false alarms, such as for one example, the sub-string “prev” contained within the word “prevalent”. The output of module 330 is the filtered text-only page data 340. In step 360 this filtered text data 340 is examined for any possible progression identifiers which are then passed on to module 350 as progression indicators 370. In module 350, the page data is further examined to determine whether hyperlinks can be found in close proximity to the identified potential progression indicators. This examination of links 390, 392 and 394 is performed in combination with progression indicator links 370. The resultant output of this step are possible progression links 230.

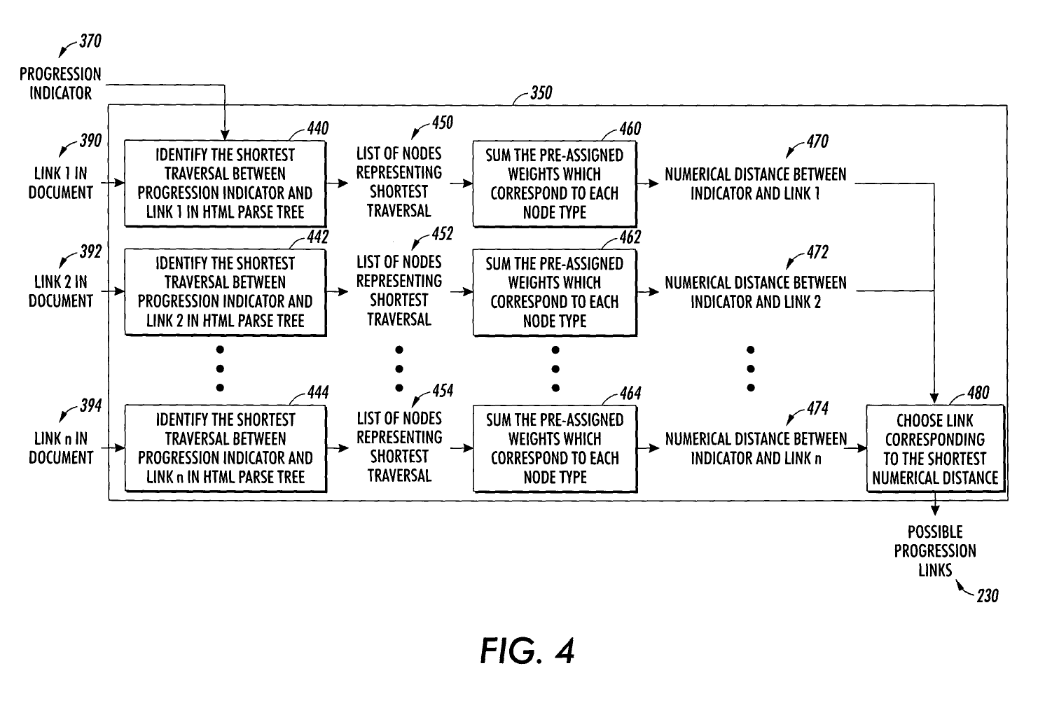

FIG. 4 provides extended description of module 350 internal operation. For the determination of each potential progression indicator 230, a heuristic approach is used to identify the most proximal link as a user would perceive it. Possible heuristics include the pixel distance in the rendered web page, node distance in the HTML parse tree, etc. One such heuristic is described in FIG. 4. For each progression indicator 370, the document's logical structure is examined by module 440 to find shortest traversal 450 between it and each candidate hyperlink 390 through to the “nth” link 394. For HTML documents, this is the list of nodes for the shortest traversal in the HTML parse tree. A numerical distance score 470 for the traversal path 450 is calculated by module 460 by summing weights associated with each node type. Module 480 then compares scores, choosing the most proximal link 230 having the lowest score for the progression indicator 370. This same procedure is performed for all of the progression indicators 370 and all of the page links 392—394, either concurrently or sequentially depending upon what reflects the best utilization of available system resources.

Then a system of fuzzy logic is employed to assess whether this most proximal link 230 is likely to be a true progression indicator. In one implementation of this invention, three assumptions are used to construct this logic:

1) If the progression indicator was a textual clue, it should stand by itself or be part of a relatively small sentence or sentence fragment. A progression indicator appearing within a large block of homogeneous text is less likely to indicate a true progression link.

2) If the progression indicator was not contained within a link, then the associated link should be relatively close by. As the perceived distance between the progression indicator and its most proximal link increases, it becomes less likely that the progression indicator indicates a true progression link. (The same heuristic employed to determine most proximal link can also be used in this circumstance to assess the relative distance.)

3) One common characteristic of all intra-document links is that the destination URL of the link tends to be similar to the source URL. It is believed that most multi-page web documents are contained within a single web server. Furthermore, the pages within a single document will tend to be clustered in the same portion of a website's directory hierarchy, often with all URLs residing in the same directory. In many cases, the URLs may even exhibit similar filenames (e.g., “paper1.htm”, “paper2.htm”, etc.). In other words, the more similar the link target is to the source URL, the more likely that this is a true progression link.

Returning to FIG. 2, module 220 examines the page data 270 to identify link clusters. It is assumed that in a well-authored hypertext page, table of contents links will appear in clusters, thereby indicating to the user that all of these links are part of a single cohesive construct. Given this assumption, the first step in locating a table of contents is to locate all of the link clusters in a particular page.

The Identification of link clusters is based on three criteria:

1) Proximity: The links in a cluster should be close together. The same heuristic as applied to identification of the most proximal link for a progression indicator can be used here to identify groups of links that have a low perceived distance.

2) Similarity: The links in a cluster should look like each other, i.e. they will usually all be of the same font, type size, and color.

3) Regularity: If there is intervening content between the links, or if the links are dissimilar, these lapses in Proximity and Similarity should form some sort of consistent pattern. One example is a table of contents where each link has a chapter description below it (Proximity is low, but the pattern of intervening content is highly consistent). Another example is a table of links where the color of the text alternates in each column in order to make it more readable (Similarity is low, but the changes in appearance form a simple pattern).

Regularity is measured by performing pattern matching on the intervening content and document structure tags between pairs of nearby links. The other two criteria are easily measured by simple heuristics.

Once all link clusters in a web page have been identified, the task remains of distinguishing which clusters represent tables of contents and which represent other constructs, such as navigation bars or bibliographies. The primary determining criteria for this is the similarity between the link targets of the links in the cluster, i.e. collocation on the same server, residence in the same directory or nearby area of the directory hierarchy, and similarity in filename.

In module 250 of FIG. 2 a final examination is made of all the links identified by either the progression analysis 210 or the cluster analysis 220. This module 250 identifies any hyperlinks that are significantly different in a property that is typical of intra-document links. The different link is filtered out. Thus a link to a page on a different server form all the others would be removed.

Once the page-level link analysis has been completed for the starting page identifier 110, a list of candidate pages 120 is compiled. These include all pages identified so far that may be part of the document: the starting page identifier plus the destination of any links that seem to indicate a page within the same document. The page-level link analysis is then applied to any of the candidate pages that have not yet been analyzed. This process is applied recursively until all candidate pages have been analyzed, or some arbitrary stopping point has been reached (e.g. maximum document size has been reached, or some maximum amount of time has elapsed).

At the conclusion of the first phase, a set of candidate page identifiers has been developed that are believed to have a high likelihood of relation to each other as a result of connection by likely intra-document links. In addition, progression links 230 and table of contents links 240 have been identified for each of these page identifiers, yielding a classified link topology, which extends the notion of classical link topology by classifying something about the nature of each link (progression vs. table of contents links vs. other). At this point, a full list of candidate pages 120 has been obtained, which should at the least contain all pages that reside within the document in question. However, it is not unlikely that the list of candidates will also contain extraneous pages. For this reason, a document-level analysis phase may optionally be performed.

The goal of the second phase is to take this set of candidate pages, as well as the classified link topology that accompanies it, and identify one or more subsets that closely match the characteristics of a document boundary. In one implementation, this is accomplished by two primary methods: correlation by content and/or meta-data, and identification of known document structures within the classified link topology.

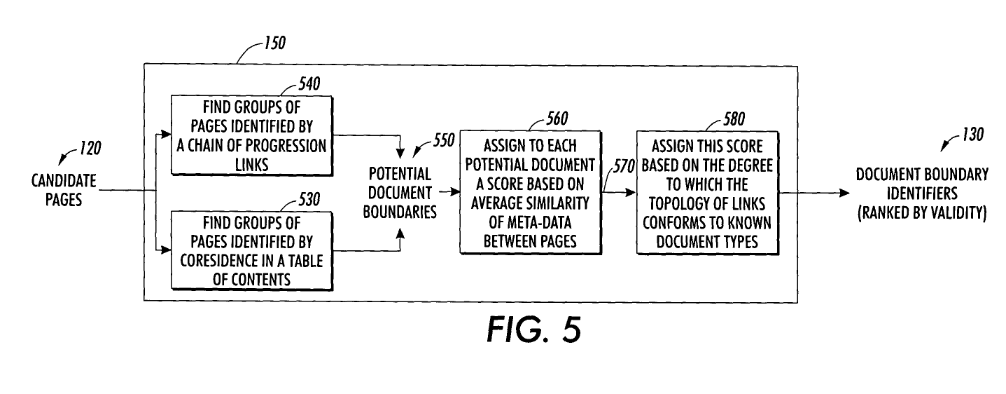

FIG. 5 describes a system methodology that performs the optional second stage of the processing, that is, the document-level analysis 150. The set of candidate pages 120 from the page-level link analysis are provided as input to the document-level analysis 150. The end-result of document-level analysis 150 is a set of document boundary identifiers 130 ranked by a score of their validity likelihood. Applications requiring a single boundary can use the most likely of the potential boundaries identified by analysis stage 150.

Subsets of the set of candidate page identifiers are identified as potential document boundaries by two methods. Module 530 selects candidate page identifiers by co-residence within the same table of contents. Module 540 identifies candidate page identifiers by chaining together progression links. In the former case, the source page is generally added to the list of page identifiers from a given table of contents, since not all tables of contents contain the self-referential link. The potential document boundaries 550 are then analyzed by module 560 and assigned a score based on the degree to which they exhibit document-like characteristics.

It would seem to be a safe assumption that web pages within the same document should have some kind of relationship by topic and share the same author or group of authors. At this stage, the candidate pages are examined for similarities (e.g. meta-tags indicate they have the same author, or the page titles are similar) It is suggested that this correlation be established by performing pattern matching on meta-data associated with the candidate pages. For example, for HTML encoded web pages, the “<META>” tags that may or may not accompany each web page can be used as a source of meta-data. This aspect of document boundary identification is referred to as meta-data correlation. The average fraction of matching “<META>” tags between pairs of web pages within each potential document boundary is a component of their final score.

Other tests for page similarity are possible. Keywords extracted directly from the page content can be compared. The style settings, the page layout structure and logical structure of the page content can also be compared. One can also look for common content items (logos, navigation bars, titles) that are shared by all pages. All such comparisons can be combined to form the similarity component of the final score.

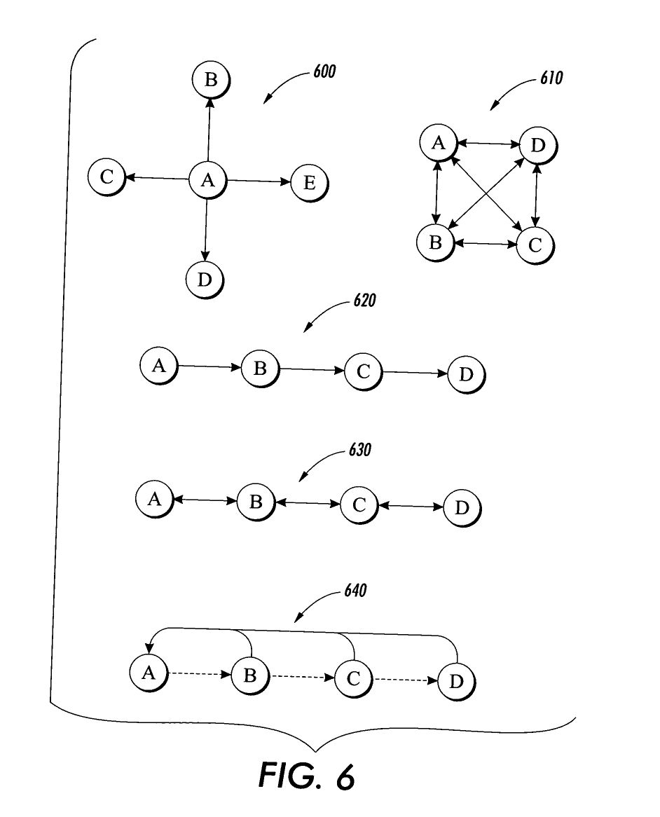

The other component of the document boundary score is determined by module 580. This module calculates the degree to which the topology of the potential document boundary corresponds to common document structures. A number of basic document structure types have been identified in FIG. 6, each of which rely not only on the configuration of links in a document, but also on the classification of each link in the structure. These simple structures can be combined, either as a compound structure or as a hierarchical structure, in order to form the rich tapestry of possible document structures. The identified document types are:

1) Centralized Table of Contents 600: A single hub page links to each of the other pages in the document via table of contents links.

2) All-connected Table of Contents 610: Each page in the document contains a complete table of contents linking to all other pages in the document.

3) Progression Chain: A series of progression links provides a path through the document. This path may be unidirectional 620 progression chain (i.e. only “next” links) or it may be bidirectional 630 progression chain (i.e. both “next” and “previous” links)

4) Return Links 640: Each page in the document has a return link to the first page in the document. This structure is only valid if used in conjunction with another document type, like a progression chain 620/630 or centralized table of contents 600.

Each common document structure type is assigned a point value based on how strong the structure is and on the probability of it arising by random chance. The sum of the point values corresponding to all of the document types exhibited by a potential document boundary is added to its score. A list 130 of document boundary identifiers ranked by validity is thereby provided from block 580.

In closing, herein above is provided a methodology for assembling a document from content spanning multiple web-pages employing two cooperative processes. Given a starting location, one process analyzes a single page at a time to find candidate links. The links are recursively followed and those pages are analyzed. A detailed set of heuristics is used to determine what is or is not a candidate link. The candidate pages are then fed to a document-level analyzer. This process compares the attributes of one page against the others and looks for a document-like structure. Using another detailed set of heuristics, the document-level analyzer determines if the page should be included in the document.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. An automated identification methodology for assembling document related hyperlinked pages comprising:
performing a page-level link analysis that identifies those hyperlinks on a page linking to a candidate document page potentially part of the document;
performing a recursive application of the page-level link analysis to the linked candidate document page and any further nested candidate document pages thereby identified, until a collective set of identified candidate document pages is assembled; and,
performing a document-level analysis that examines the collective set of identified candidate document pages for grouping into one or more documents.

2. The method of claim 1 wherein the page-level link analysis includes retrieval of referenced pages.

3. The method of claim 1 wherein the page-level link analysis includes examination of contextual clues.

4. The method of claim 3 wherein the contextual clue is a particular class of content item associated with the hyperlink.

5. The method of claim 4 wherein the class of content item is a class of text.

6. The method of claim 5 wherein the class of text is a directional word or phrase.

7. The method of claim 4 wherein the class of content item is a class of image.

8. The method of claim 7 wherein the class of image is an image containing a directional symbol.

9. The method of claim 4 wherein a textual clue is obtained for the image.

10. The method of claim 1 wherein the page-level link analysis includes the identification of progression links.

11. The method of claim 3 wherein the contextual clue is the presence of at least one other hyperlink nearby with the document description.

12. The method of claim 3 wherein the contextual clue is the similarity of the hyperlink destination to that of other hyperlinks with the document.

13. The method of claim 1 wherein the page-level link analysis includes the identification of tables of contents.

14. The method of claim 1 wherein the document-level analysis includes the identification of pages forming a chain of progression links.

15. The method of claim 1 wherein the document-level analysis includes identifying the pages listed in a table of contents.

16. The method of claim 1 wherein the document-level analysis includes identifying as part of the document the page containing the table of contents.

17. The method of claim 1 wherein the document-level analysis includes the similarity of candidate pages.

18. The method of claim 17 wherein the similarity includes the location at which the page is stored.

19. The method of claim 17 wherein the similarity includes the similarity of meta-data associated with the page.

20. The method of claim 19 wherein the meta-data includes the author identification.

21. The method of claim 17 wherein the similarity includes similar style specifications.

22. The method of claim 17 wherein the similarity includes similar page layout.

23. The method of claim 17 wherein the similarity includes similar logical structure of the page content.

24. The method of claim 17 wherein the similarity includes the presence of at least one similar content item on each page.

25. The method of claim 1 wherein the document-level analysis includes analysis of the topological structure of the linked pages.

26. A system identification methodology for assembling a hyperlinked document comprising:
performing a page-level link analysis that identifies those hyperlinks on a page linking to a candidate document page further comprising a methodology of:
identifying possible progression links, and;
identifying possible table of content links;
performing a recursive application of the page-level link analysis to the linked candidate document page and any further nested candidate document pages thereby identified, until a collective set of identified candidate document pages is assembled; and,
performing a document-level analysis that examines the collective set of identified candidate document pages for grouping into one or more documents.

27. The method of claim 26 wherein the page-level link analysis includes examination of contextual clues.

28. The method of claim 27 wherein the contextual clue is a particular class of content item associated with the hyperlink.

29. The method of claim 28 wherein the class of content item is a class of text.

30. The method of claim 29 wherein the class of text is a directional word or phrase.

31. The method of claim 28 wherein the class of content item is a class of image.

32. The method of claim 31 wherein the class of image is an image containing a directional symbol.

33. The method of claim 28 wherein a textual clue is obtained for the image.

34. The method of claim 27 wherein the contextual clue is the presence of at least one other hyperlink nearby with the document description.

35. The method of claim 27 wherein the contextual clue is the similarity of the hyperlink destination to that of other hyperlinks with the document.

36. The method of claim 26 wherein the document-level analysis includes the identification of pages forming a chain of progression links.

37. A system identification methodology for assembling a hyperlinked document comprising:
performing a page-level link analysis that identifies those hyperlinks on a page linking to a candidate document page further comprising a methodology of:
identifying possible progression links;
identifying possible table of content links, and;
examining the possible progression links and the possible table of content links for common characteristics;
performing a recursive application of the page-level link analysis to the linked candidate document page and any further nested candidate document pages thereby identified, until a collective set of identified candidate document pages is assembled; and,
performing a document-level analysis that examines the collective set of identified candidate document pages for grouping into one or more documents.

38. The method of claim 37 wherein the page-level link analysis includes examination of contextual clues.

39. The method of claim 38 wherein the contextual clue is a particular class of content item associated with the hyperlink.

40. The method of claim 39 wherein the class of content item is a class of text.

41. The method of claim 40 wherein the class of text is a directional word or phrase.

42. The method of claim 39 wherein the class of content item is a class of image.

43. The method of claim 42 wherein the class of image is an image containing a directional symbol.

44. The method of claim 39 wherein a textual clue is obtained for the image.

45. The method of claim 38 wherein the contextual clue is the presence of at least one other hyperlink nearby with the document description.

46. The method of claim 38 wherein the contextual clue is the similarity of the hyperlink destination to that of other hyperlinks with the document.

47. The method of claim 37 wherein the document-level analysis includes the identification of pages forming a chain of progression links.

48. The method of claim 37 wherein the document-level analysis includes the identification of pages linked to by the same tables of contents.
